(19) United States
(12) Patent Application Publication
(10) Pub. No.: US 2026/0237192 A1
(43) Pub. Date: Aug. 13, 2026

(54) IN-DOMAIN DATA EXPANSION FOR VISION MODEL TRAINING

(71) Applicant: SAP SE, Walldorf (DE)

(72) Inventors: Ankush Mishra, Singapore (SG); Rahul George, Singapore (SG); Rajesh Vellore Arumugam, Singapore (SG); Anantharaman Ravi, Singapore (SG)

(21) Appl. No.: 19/051,817

(22) Filed: Feb. 12, 2025

(51) Int. Cl. G06V 10/774; G06T 5/77; G06V 10/72; G06V 10/74; G06V 10/764

(52) U.S. Cl. CPC G06V 10/774; G06T 5/77; G06V 10/72; G06V 10/761; G06V 10/764; G06T 2207/20081

(57) ABSTRACT

Systems and methods described herein relate to data expansion techniques for machine learning. A generative model trained on an initial dataset generates candidate images based on input images and corresponding class labels. A mask is applied to each candidate image to obtain masked images that are then reconstructed using the generative model. Candidate images are filtered by removing those that are too dissimilar when compared to their reconstructed versions. The remaining candidate images are combined with the initial dataset to form an expanded dataset.

### TECHNICAL FIELD

The subject matter disclosed herein generally relates to data expansion technologies for use in machine learning. Particularly, but not exclusively, the subject matter relates to techniques for the creation and validation of synthetic data using generative artificial intelligence (AI).

### BACKGROUND

Many computer vision systems rely on machine learning models to perform tasks such as image classification and object detection. In this context, large and diverse datasets are often needed for training effective computer vision models. For example, an image classifier model can learn, based on a training dataset of images with corresponding class labels, to classify input images as “defective” (e.g., the image shows a defective product) or “non-defective” (e.g., the image shows a product with no visible defects).

If datasets are too small or overly imbalanced, computer vision models may struggle to learn robust features or generalize effectively to new or varied inputs. Obtaining suitable datasets can be challenging, especially when limited real-world data is available (e.g., due to the limited presence of certain class labels, annotation challenges, data access restrictions, or privacy concerns). For example, the training dataset for the aforementioned image classifier model might contain only one or two defective samples for every 10,000 or 20,000 non-defective samples. This scarcity can limit the ability of a computer vision model to generalize, leading to technical problems such as overfitting, poor feature learning, or reduced reliability when encountering new or varied inputs.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a dataset expansion system, according to some examples.

FIG. 2 is a block diagram illustrating components of a dataset expansion system and components of a machine learning system, according to some examples.

FIG. 3 is a flowchart illustrating a method for dataset expansion, according to some examples.

FIG. 4 is a diagrammatic representation of a dataset expansion pipeline, according to some examples.

FIG. 5 is a block diagram illustrating components of a machine learning system, according to some examples.

FIG. 6 is a flowchart illustrating a machine learning pipeline, according to some examples.

FIG. 7 is a system architecture diagram showing a layered view of an AI integrated system, according to some examples.

FIG. 8 is a block diagram of a computing system, according to some examples, within which instructions may be executed to perform one or more of the methodologies discussed herein.

### DETAILED DESCRIPTION

Data augmentation can be used to expand datasets for machine learning model training. In a classification context, data augmentation typically involves applying transformations to existing data to create slightly altered versions while retaining original labels. This may include techniques such as cropping or rotating images, adjusting lighting or colors, image shifting, or random erasing. These techniques can help by adding additional samples to a dataset but provide limited feature diversity. For example, rotating an image of a defective product creates an additional view, but the new image has the same class and highly similar content when compared to the original, which may not greatly facilitate the learning of new or broader defect patterns.

Synthetic image generation is another technique for data expansion. It typically involves creating artificial images using one or more computational processes. Synthetic generation can enhance datasets by introducing novel variations, thereby improving feature diversity to a greater extent compared to what is typically possible with conventional data augmentation. Further, synthetic image generation can address dataset imbalances to enable a computer vision model to learn better from underrepresented classes or handle complex scenarios that might otherwise be overlooked.

While synthetic data generation can provide technical benefits, it often carries the risk of distribution shifts, which can degrade model performance with out-of-distribution (OOD) samples. For example, generated images might not be sufficiently in domain due to artifacts, distortions, or unrealistic features in the synthetic data that do not exist (or are highly unlikely to exist) in real-world data, and essentially “mislead” machine learning models during training.

Examples in the present disclosure facilitate in-domain data expansion for the training of computer vision models. In some examples, a system according to the present disclosure leverages a generative model (e.g., a diffusion model) for data expansion and employs a distribution-aware image synthesizing process to ensure class-specific image generation. To minimize OOD samples and mitigate risks such as hallucinations, image reconstruction is employed to verify alignment with the original dataset's distribution.

In some examples, the system implements a unified two-stage approach, utilizing the same generative model across both stages to generate and validate a rich variety of in-domain data samples in an efficient manner. The first stage can involve class-aware image generation to provide candidate synthetic images for a given input image. The second stage can involve image inpainting and candidate validation, ensuring that the candidate images remain within the original data distribution. Resulting synthetic samples that are validated can be combined with an original dataset, forming an expanded dataset that captures a broader array of variations while staying true to the original data distribution.

A computing system can perform a computer-implemented method to expand an initial dataset (e.g., an original dataset that is deemed to be limited or unsatisfactory, and thus selected for expansion). In some examples, the initial dataset includes a collection of labeled images used for training machine learning models. In some examples, the initial dataset contains images with corresponding class labels that represent different categories or conditions, such as defective and non-defective samples in manufacturing applications. The initial dataset may be imbalanced, with some classes having significantly fewer examples than others. The initial dataset may include real data, synthetic data, or combinations thereof.

The method may include training a generative model (e.g., a diffusion model) on the initial dataset. The generative model is then used to generate candidate images for expanding the initial dataset.

The method may include accessing a plurality of input images from a data source and generating candidate images for each input image. In some examples, the data source is the initial dataset. In some examples, the generation of these candidate images is based on both the relevant input image and its corresponding class label.

The specific number of candidate images generated for each input image may vary. In some examples, this number is between two and ten. In some examples, the number of candidate images is the same for each input image. In other examples, the system applies different numbers for different input images (e.g., to dynamically control class distribution).

In some examples, the system predicts the class label for the input image. The method may include executing an image classifier model trained on the initial dataset to predict the class label for the input image. Various class labels can be employed, depending on the implementation. For example, binary classification tasks (e.g., “defective” or “non-defective”) or multi-class classification tasks (e.g., classifying defect type from among more than two available types) can be supported.

The method may further include automatically applying a mask to each of the generated candidate images to obtain masked images, followed by automatically reconstructing these masked images to obtain reconstructed images. The reconstruction process may involve executing the same generative model that generated the initial candidate image. The generative model can use both the masked image and a predicted class label for the relevant candidate image (that was used to generate the masked image) as inputs for reconstruction.

A masked image may include a computer-generated image that has one or more portions or zones obscured through the application of a mask (e.g., a masking pattern or masking template). In some examples, the masked image is generated by applying a checkerboard masking template to a candidate image generated by a generative model. The masking process serves as a structural guidance mechanism that indicates which portions of the image need to be reconstructed during validation.

A reconstructed image may include a computer-generated image generated by attempting to restore the masked portion or portions of a masked image (e.g., using a generative model). In some examples, the reconstructed image is produced by providing both the masked image and its corresponding class label as inputs to the generative model. In some examples, the reconstructing of the plurality of masked images comprises performing image inpainting.

In some examples, the method includes performing image inpainting to obtain intermediate output (e.g., using the same generative model that created the candidate image). The intermediate output can be a first reconstructed version of the image. Then, a system according to some examples extracts regions associated with the mask from the intermediate output and overlays or combines those regions with the masked image, or overlays those regions on the original candidate image, thereby creating a final reconstructed version of the image for comparison with the original candidate image. In other words, the system automatically generates a reconstruction version that combines the parts of the original candidate image that were not masked with a generative model's prediction for the appearance of the masked regions.

For each input image, a filtering operation can be performed on the plurality of candidate images to obtain validated images. The filtering operation can assess each candidate image and its corresponding reconstructed image. In some examples, the filtering process includes removing certain candidate images based on their dissimilarity when compared to their corresponding reconstructed images. The filtering process may include generating a value, such as a perceptual distance score, that indicates the similarity between each candidate image and its corresponding reconstructed image. This value may then be compared against a predetermined threshold to determine whether the candidate image should be removed.

Accordingly, in some examples, the quality of reconstruction serves as an indicator of whether the original candidate image aligns well with the learned data distribution of the generative model. In this way, the system can ensure that synthetic images to be added to the initial dataset conform, or are more likely to conform, to the data distribution.

The method may include storing an expanded dataset that comprises both the initial dataset and the validated images associated with each of the input images. In some examples, where the initial dataset is an imbalanced classification dataset, the method may compensate for this imbalance by dynamically controlling either the selection of input images from a data source or the number of candidate images generated from the input images. This may include oversampling from one or more minority classes present in the initial dataset to increase their proportion in the expanded dataset.

The expanded dataset may thus include a combination of the initial dataset and validated synthetic images generated through the data expansion process. In some examples, the expanded dataset is created by combining the original images with synthetic images that have passed distribution alignment validation. In some cases, only a subset of data from the initial dataset is combined with the validated synthetic data to form the expanded dataset. In some examples, the expanded dataset maintains class labels for images.

The method may include training a model on the expanded dataset. For example, the expanded dataset is used by a computing system to train an image classifier model to predict whether a depicted product has a defect.

Examples in the present disclosure provide a system and method for automatically adding relevant training data, enhancing diversity in training data, or both, when faced with a limited or unsatisfactory set of initial data. By creating synthetic samples, the system can improve the representation of minority classes, reducing dominance of majority classes and mitigating class imbalance. An expanded dataset produced through this approach can be leveraged to retrain a classifier model to bolster its capabilities or to train a new classifier model based on data with reduced biases compared to the original data. In some examples, the technology of the present disclosure allows for dynamic adjustment of parameters, such as the number of synthetic images generated per input and the similarity threshold used for filtering.

The present disclosure provides various technological solutions to technological challenges. One technological challenge when generating synthetic images to be added to an original dataset is that of alignment with the original dataset distribution. Generated images can suffer from distribution shifts and model hallucinations, where the generative model produces images that deviate significantly from the target domain's characteristics. This leads to degraded model performance when training with OOD samples. The technological challenge can be addressed or alleviated using approaches described herein. For example, the system produces synthetic data conditioned on sample class, reducing distribution shifts and ensuring alignment with the original dataset. Furthermore, the system applies automatic filtering for distribution control.

A further technological challenge is that of learning robust features when trained on limited datasets. The scarcity of diverse examples, particularly in minority classes, can create a technical barrier to effective feature extraction and representation learning. This results in poor generalization capabilities and reduced reliability when the model encounters new or varied visual inputs.

Examples in the present disclosure address this technological challenge by enhancing data diversity. In some examples, the system implements dynamic data expansion controls. For imbalanced classification datasets, the system automatically compensates by controlling either the selection of input images from the data source or adjusting the number of candidate images generated from input images. The system can oversample from minority classes to increase their proportion in the expanded dataset, thereby automatically generating novel variations for minority classes and reducing overfitting on majority classes. The expanded dataset, comprising both the initial dataset and validated synthetic images, provides additional diverse examples for training while maintaining distribution alignment through the class-aware generation process.

Another technological challenge is computational inefficiency in synthetic data pipelines. For example, a synthetic data generation pipeline may rely on multiple specialized models, such as a first specialized model for image generation and a separate specialized model for validation or quality control. This adds to computational overhead and increases the complexity of the data expansion pipeline.

Examples in the present disclosure address this technological challenge by utilizing a single pretrained generative model for both generation (the first stage in the two-stage pipeline) and validation (the second stage in the two-stage pipeline). For example, the same model that generates synthetic images also performs the reconstruction operations. In other words, a single model generates new images and facilitates identification of outliers, eliminating or at least reducing the need for multiple specialized models. In some examples, a single pretraining phase in which the generative model is trained on the initial dataset distribution is sufficient, with no further training of the generative model being needed. In other words, and for example, the same model (with the same pretrained parameters) is used in a candidate image generation phase and in a reconstruction (e.g., inpainting) phase. This streamlines the data expansion process and reduces the computational burden on a synthetic data generation pipeline.

The subject matter of the present disclosure provides concrete technical improvements to computer vision systems. The technology described herein provides measurable performance gains, including downstream improvements to classification accuracy. Model performance in limited-data scenarios can be boosted by generating class-specific, relevant samples, with such samples introducing feature diversity and enhancing dataset richness. The technology described herein further demonstrates improved robustness in computer vision systems through its distribution-aware validation mechanism.

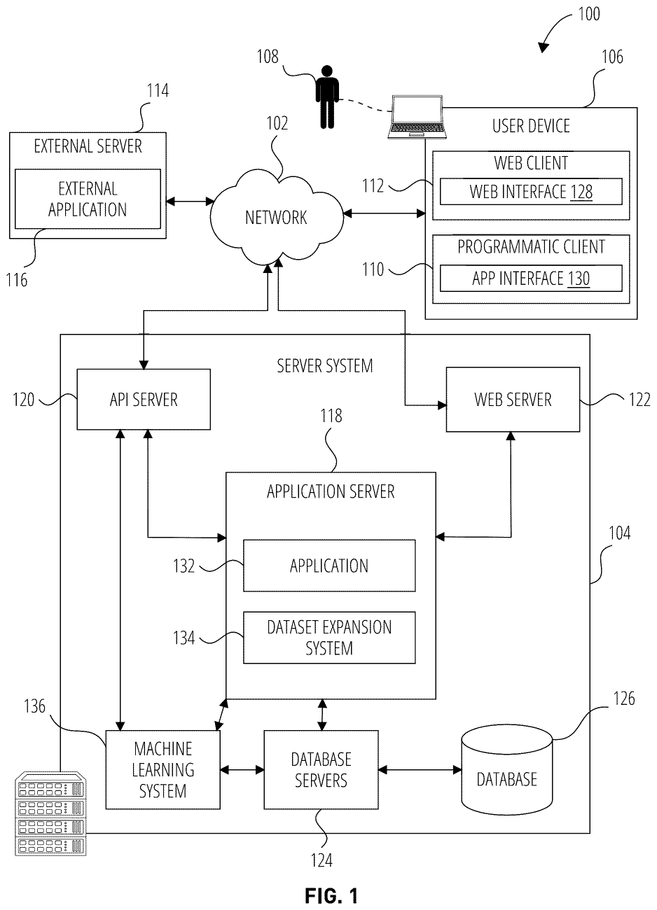

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 112 (e.g., a browser) or a programmatic client 110 (e.g., an “app”) may be hosted and executed on the user device 106.

An Application Program Interface (API) server 120 and a web server 122 provide respective programmatic and web interfaces to components of the server system 104. An application server 118 hosts an application 132 and a dataset expansion system 134, each of which can include one or more components, modules, or applications. In some examples, multiple different application servers can be employed for this purpose.

The user device 106 can communicate with the application server 118 via the web interface supported by the web server 122 or via the programmatic interface provided by the API server 120. It will be appreciated that, although only a single user device 106 is shown in FIG. 1, a plurality of user devices may be communicatively coupled to the server system 104.

The application server 118 is communicatively coupled to a machine learning system 136. The application server 118 is further communicatively coupled to database servers 124, facilitating access to one or more information storage repositories, such as a database 126. In some examples, the database 126 includes storage devices that store information to be processed by the application 132, the dataset expansion system 134, or the machine learning system 136. The information may include machine learning model training data.

The application server 118 accesses application data (e.g., application data stored by the database servers 124) to provide one or more applications, features, or software tools to the user device 106 via a web interface 128 or an app interface 130. The application 132 is an example of an application that can be provided to the user device 106.

For example, in a manufacturing context, the application 132 provides features of a defect inspection system. The defect inspection system is communicatively coupled to various manufacturing facilities (or other related facilities, such as assembly facilities or quality control facilities) to provide digital manufacturing tools or services. At the facility level, various sensors or devices can collect data as part of a production process. These sensors or devices can be connected to local controllers, which may perform initial data processing and aggregation (at least in some examples). Data is then transmitted to the server system 104, allowing for one or more functions to be performed, such as defect inspection, analytics, reporting, or integration with other processes. For instance, the database 126 remotely stores input data collected by local sensors, and the defect inspection system applies machine learning algorithms to analyze the data, and further uses the results to determine which actions to perform or trigger. To this end, the application 132 may provide one or more dashboards via a graphical user interface (GUI) on the user device 106, such as a dashboard that summarizes inspection results or allows the user 108 to provide feedback or exercise control over certain aspects of such inspections.

It is noted that while manufacturing (e.g., product defect detection in a manufacturing context) is used to describe certain examples in the present disclosure, such as an example of the application 132 of FIG. 1, the described techniques of the present disclosure can be applied across various domains and classification tasks. In other words, various techniques described herein are not limited to manufacturing environments or defect classification applications, and can also be applied to other types of systems involving datasets that may benefit from synthetic samples with, for example, high fidelity, diversity, and alignment with an original data distribution.

The machine learning system 136 can provide machine learning models used for generating predictions within automated processes (e.g., to generate a prediction as to whether an inspected item is “defective” or “non-defective” or generate a prediction of a defect type). The machine learning system 136 may provide various capabilities, such as training models, deploying predictions, and monitoring performance. The machine learning system 136 may leverage training datasets (e.g., stored in the database 126) to construct machine learning pipelines and train or re-train (e.g., adjust) machine learning models used by the defect inspection system associated with the application 132.

The dataset expansion system 134 is an example of a tool that can be provided to the user device 106. The dataset expansion system 134 is configured to enable expansion of datasets. For example, the dataset expansion system 134 can be used by the user 108 to trigger the adding of data items to an initial dataset to create an expanded dataset to be used by the machine learning system 136 for model training. As an example, the expanded dataset might be a collection of images with class labels indicating whether a product is defective. The expanded dataset is then used to train or adjust a computer vision model for use in the context of the application 132.

The dataset expansion system 134 may also provide one or more dashboards via a graphical user interface (GUI) on the user device 106, such as a dashboard that enables a user 108 to control settings of the data expansion pipeline. For instance, the user 108 might use the GUI of the dataset expansion system 134 via the web interface 128 or the app interface 130 to select a data source for input images to be fed into the data expansion pipeline, to select the number of candidate images to be generated for each input image, to control validation or filtering thresholds of the dataset expansion system 134, or to view expansion process results.

In some examples, the dataset expansion system 134 operates as a comprehensive framework for expanding limited datasets while maintaining data distribution alignment. The dataset expansion system 134 includes various components that work together to generate and validate synthetic images. The dataset expansion system 134 may interface with the machine learning system 136 to coordinate the data expansion process. For example, the dataset expansion system 134 can use trained models that are executed by the machine learning system 136 as part of a data expansion pipeline.

In some examples, the application server 118 is part of a cloud-based platform provided by a software provider that allows the user 108 to utilize the application 132 or the dataset expansion system 134. For example, an account holder may access one or more cloud instances to communicate with the application 132 or the dataset expansion system 134.

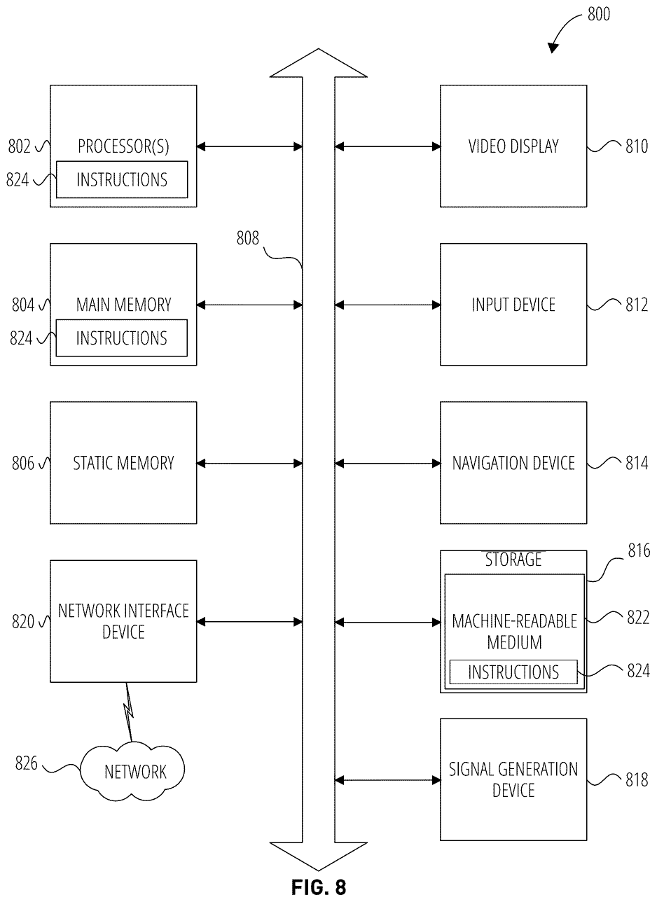

One or more of the application server 118, the database servers 124, the API server 120, or the web server 122 may each be implemented in a computer system, in whole or in part. This can include, for example, a computing environment as described below with respect to FIG. 8. In some examples, external applications, such as an external application 116 executing on an external server 114, can communicate with the application server 118 via the programmatic interface provided by the API server 120. For example, a third-party application may support one or more features or functions on a website or platform hosted by a third party, or may perform certain methodologies and provide input or output information to the application server 118 for further processing or publication.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

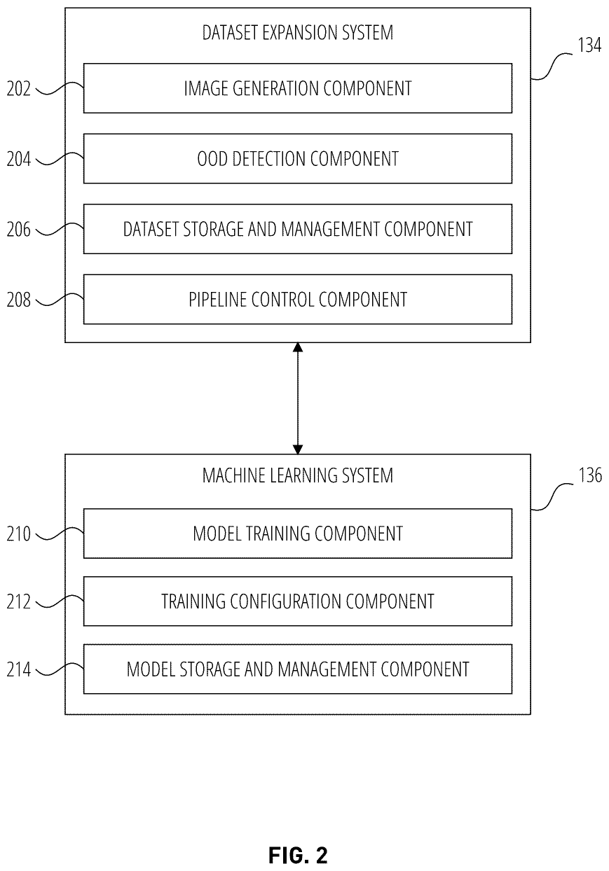

FIG. 2 is a block diagram illustrating components of the dataset expansion system 134 of FIG. 1 and components of the machine learning system 136 of FIG. 1, according to some examples. In FIG. 2, the dataset expansion system 134 is shown to include an image generation component 202, an OOD detection component 204, a dataset storage and management component 206, and a pipeline control component 208. The machine learning system 136 is shown to include a model training component 210, a training configuration component 212, and a model storage and management component 214.

Referring firstly to the dataset expansion system 134, the image generation component 202 of the dataset expansion system 134 is configured to generate synthetic images based on input images and their respective class labels. In some examples, the image generation component 202 leverages a generative model accessible via the machine learning system 136 to generate synthetic images. A diffusion model (e.g., Stable Diffusion) is an example of such a generative model. In some examples, the generative model is trained on an initial dataset that is intended to be expanded.

The image generation component 202 performs class-aware image generation. In some examples, in addition to conditioning image generation on class, the image generation component 202 detects or predicts the relevant class label for each input image before performing the image generation process. For example, the image generation component 202 leverages an image classifier model accessible via the machine learning system 136 to predict class labels. A residual network (ResNet) and a Vision Transformer (ViT) are examples of such image classifier models. In some examples, the image classifier model is also trained on the initial dataset that is intended to be expanded.

The OOD detection component 204 is responsible for automatically checking generated images to ensure they remain within an original data distribution, or are likely to be within such distribution. In some examples, the OOD detection component 204 performs masking and reconstruction operations to identify potential OOD samples. For example, the OOD detection component 204 applies a mask to each candidate image and then automatically reconstructs the masked image to obtain a reconstructed image. The OOD detection component 204 then compares the reconstructed image with the original candidate image. If the reconstructed image is not sufficiently similar to the original candidate image, the OOD detection component 204 flags the candidate image as OOD.

Image reconstruction may involve image inpainting, also referred to as image completion. In this context, inpainting refers to the addition, by a computerized process, of new content to an image in specified regions. For example, the OOD detection component 204 runs the same generative model that generated the initial candidate image to reconstruct a masked version of the candidate image. In this way, the generative model automatically fills “missing” regions in the image by attempting to harmonize such regions with the other portions of the image.

Various types of masks can be applied. In one example implementation, during operation, the OOD detection component 204 randomly applies one of two complementary “checkered” masking templates. For instance, one pattern resembles a chess board and masks certain square regions while leaving others visible, and the second pattern is the inverse-masking the squares that are visible in the first pattern while revealing the ones that are masked in the first pattern. Each of these patterns ensure coverage of the image while maintaining structural information, allowing the dataset expansion system 134 to verify reconstruction quality across the entire image.

The OOD detection component 204 can apply a threshold to determine whether to filter out OOD candidate images. For example, the OOD detection component 204 calculates a perceptual distance score between each candidate image and its reconstruction, and filters out the candidate image if the perceptual distance score exceeds a predetermined threshold.

One example of a perceptual distance scoring technique is the Learned Perceptual Image Patch Similarity (LPIPS) technique. LPIPS is a measure of dissimilarity that has been shown to correlate with human perception of similarity. LPIPS calculates perceptual similarity between two images. A lower score means that images are more similar, while a higher score means that images are less similar.

In one example implementation, the predetermined threshold is set at 0.05. Thus, for example, if the LPIPS score exceeds 0.05, a candidate image is too dissimilar from its reconstructed version and is not validated by the OOD detection component 204. On the other hand, if the LPIPS score is equal to or less than 0.05, the candidate image is validated and can, for example, be used to expand the initial dataset. In the latter case, the OOD detection component 204 applies the principle that a candidate image with acceptable perceptual similarity is likely to conform to the distribution of the target dataset (e.g., the initial dataset to be expanded) and its addition thereto may result in a higher quality trained model.

Accordingly, in some examples, the OOD detection component 204 serves as a quality control component, identifying and removing candidate images from those generated by the image generation component 202 if they are too dissimilar, or OOD, compared to the initial dataset on which the generative model was trained. As mentioned, the same generative model that generates the candidate image can be used to validate that candidate image. This approach leverages the principle that a generative model, such as a diffusion model, can often effectively reconstruct images within the distribution it is trained on but encounters difficulties with OOD samples.

The dataset storage and management component 206 of the dataset expansion system 134 maintains data items forming part of datasets. In some examples, the dataset storage and management component 206 stores validated in-domain images that pass filtering criteria along with their associated class labels. The dataset storage and management component 206 can define an expanded dataset by combining original data items with additional data items that are validated by the OOD detection component 204.

In some examples, the dataset storage and management component 206 deletes or otherwise removes candidate images that do not pass the filtering stage. The dataset storage and management component 206 may also be configured to delete intermediate images, such as masked images, reconstructions, or other intermediate outputs (e.g., raw outputs from a generative model that are further processed to generate reconstructions), once they are no longer needed, thereby freeing up memory resources.

The pipeline control component 208 may coordinate an overall dataset expansion workflow. For example, the pipeline control component 208 manages the sequential process of generation, validation, and filtering of synthetic images. The pipeline control component 208 may dynamically adjust parameters such as the number of candidate images generated based on dataset characteristics (e.g., class imbalance). In some examples, the pipeline control component 208 receives and acts upon user input to control the workflow. For example, a user (e.g., the user 108 of FIG. 1) may provide input (e.g., via the user device 106) to adjust the threshold to be applied when using the perceptual distance score for validation.

Referring now to the machine learning system 136 as shown in FIG. 2, the machine learning system 136 provides underlying model infrastructure and training capabilities that support the data expansion process. In some examples, the machine learning system 136 manages both a generative model and a classifier model used in the expansion pipeline.

The model training component 210 of the machine learning system 136 handles the training of machine learning models used in the data expansion process. In some examples, the model training component 210 manages the supervised training of the generative model and the image classifier model, or both, on an initial dataset (e.g., the original dataset or target dataset to be expanded). In some examples, the model training component 210 also handles downstream training based on an expanded dataset. For example, once the expanded dataset has been generated using the initial dataset and the additional, validated candidate images (along with their class labels), the model training component 210 triggers training of a selected model (e.g., a binary or multiclass classifier) using the expanded dataset.

The training configuration component 212 manages various parameters and settings used during model training. This includes, for example, hyperparameters such as learning rates, batch sizes, and optimization algorithms that affect how models learn from the training data. The training configuration component 212 can dynamically adjust these parameters based on training progress and performance metrics to achieve optimal results.

The model storage and management component 214 maintains and organizes trained models and their associated data. For example, the model storage and management component 214 handles version control of models, tracks model lineage and training history, and ensures proper alignment between models and their corresponding training datasets. In some examples, the model storage and management component 214 interfaces with the dataset storage and management component 206 to maintain consistency between the models and the data used to train them, enabling effective model governance and reproducibility of results.

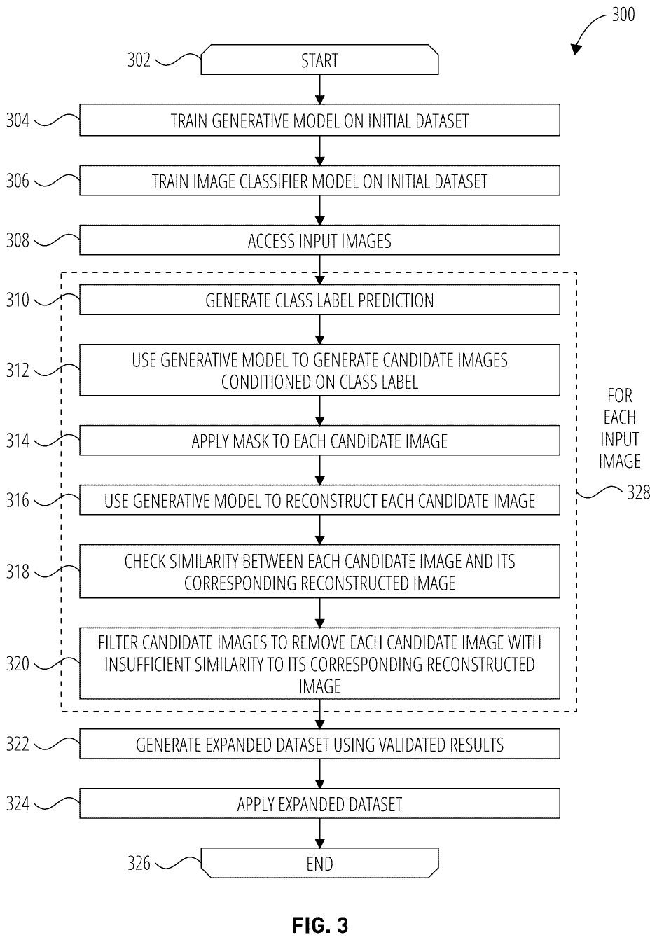

FIG. 3 is a flowchart illustrating a method 300 for dataset expansion, according to some examples. The method 300 transforms an original dataset, referred to as the initial dataset, into an enriched and expanded version, referred to as the expanded dataset. By way of example and not limitation, aspects of the method 300 may be performed by the components, systems, or elements shown in FIG. 1 and FIG. 2.

The method 300 commences at opening loop operation 302, and proceeds to operation 304, where the machine learning system 136 trains a generative model on the initial dataset. For example, the initial dataset contains images with labels indicating whether they depict defective or non-defective products, and the machine learning system 136 automatically pretrains a diffusion model using supervised learning such that the diffusion model learns the distribution characteristics of the initial dataset.

At operation 306, the machine learning system 136 trains an image classifier model on the initial dataset. Continuing with the product defect example, the machine learning system 136 pretrains a ResNet or ViT model in a supervised manner such that the relevant model learns to predict whether an image depicts a defective or non-defective product (e.g., by outputting a likelihood score). The class labels used during the pretraining phase will later guide the candidate image generation process, as described below.

At operation 308, the dataset storage and management component 206 accesses input images from the initial dataset (e.g., via the database 126). The dataset storage and management component 206 may access a subset or all of the images from the initial dataset.

For each input image from the initial dataset, and as indicated by loop 328 in FIG. 3, the dataset expansion system 134 then performs class-aware image generation and OOD filtering. At operation 310, the image generation component 202 generates a class label prediction for the input image (e.g., “defective” or “non-defective”). The predicted class label provides guidance for the subsequent generation operation. At operation 312, the image generation component 202 uses the pretrained generative model to generate candidate images (e.g., 4, 5, or 6 candidate images) based on the input image and the predicted class label.

At operation 314, the OOD detection component 204 applies a mask to each candidate image. For example, the OOD detection component 204 applies a preset pattern or randomly selects one pattern from a set of stored patterns (e.g., two checkerboard patterns). At operation 316, the OOD detection component 204 uses the same pretrained generative model to reconstruct each masked image to obtain, for each candidate image, a corresponding reconstructed image. The reconstruction process tests the ability of the generative model to accurately restore the masked portions, which serves as an indicator of whether the image aligns with the learned data distribution.

In some examples, the reconstruction process involves, for each candidate image, the OOD detection component 204 first using the generative model to generate an intermediate output. For example, the OOD detection component 204 causes the generative model to produce an intermediate output image that is generated using the masked image and the relevant predicted class label as inputs. The generative model processes the masked image and essentially predicts the appearance of the masked regions based on its training and the class label. From this intermediate output, the OOD detection component 204 extracts regions of interest. For example, the OOD detection component 204 automatically extracts the newly generated regions corresponding to the masked regions in the masked image. The extracted regions contain the generative model's reconstruction or prediction of what the masked regions should look like. These extracted regions are then overlayed onto the masked image or onto the original candidate image by the OOD detection component 204, thereby generating a final reconstructed image.

Accordingly, in some examples, masked information is utilized solely during post-processing. It is noted that by using the same generative model (e.g., SD model with the same pretrained weights) in some examples, the process can run on a lightweight design, reducing computation costs and offering other technical benefits as highlighted elsewhere in the present disclosure.

Then, at operation 318, the OOD detection component 204 checks the similarity between each candidate image and its corresponding reconstructed image. For example, the OOD detection component 204 calculates a perceptual distance score that quantifies the dissimilarity between the original generated (candidate) image and its reconstruction. This quantification of dissimilarity between the two images allows the exclusion of unsuitable images based on a decision threshold.

At operation 320, the OOD detection component 204 removes candidate images that show insufficient similarity to their reconstructed versions. In some examples, images with a dissimilarity score exceeding a predetermined threshold are identified as OOD samples and discarded. This filtering ensures that only images that maintain strong distribution alignment are retained.

The dataset expansion system 134 then generates an expanded dataset using the validated results at operation 322 (e.g., only the candidate images that are not filtered out at operation 320 are added to the initial dataset). In some examples, the expanded dataset maintains the class labels associated with the input images that generated the synthetic samples. The expanded dataset captures a broader range of data variations. Further, in some examples, the expanded dataset alleviates or reduces class imbalance in the initial dataset.

At operation 324, the expanded dataset is applied by the machine learning system 136. This may involve using the expanded dataset to train downstream machine learning models. In some examples, this expanded dataset is used to train an image classifier model, potentially improving its performance through access to a larger, more diverse yet distribution-aligned dataset. The method 300 concludes at closing loop operation 326.

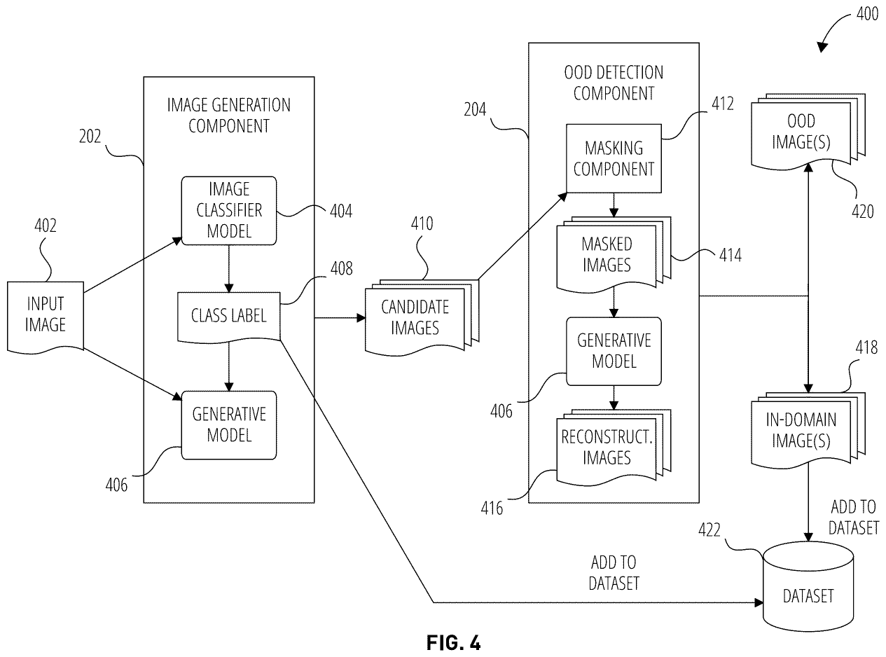

FIG. 4 is a diagrammatic representation of a dataset expansion pipeline 400, according to some examples. The dataset expansion pipeline 400 shows interconnected components and data items that enable class-aware image generation, OOD detection, and subsequent filtering for effective expansion. By way of example and not limitation, aspects of the dataset expansion pipeline 400 may be implemented by the components, systems, or elements shown in FIG. 1 and FIG. 2.

In the example of FIG. 4, the dataset expansion pipeline 400 is implemented using the image generation component 202 and the OOD detection component 204 of the dataset expansion system 134 of FIG. 1 and FIG. 2. As shown in FIG. 4, the image generation component 202 triggers execution of an image classifier model 404 and a generative model 406 to perform class-aware image generation. To this end, the image generation component 202 can work with the machine learning system 136 as described with reference to FIG. 2.

The dataset expansion pipeline 400 takes, as inputs, a plurality of input images, and generates new images based on the input images. For each input image 402, the image classifier model 404 processes the input image 402 to predict its class label 408. The generative model 406 then uses the class label 408 along with the input image 402 itself to generate candidate images 410 that maintain class-specific characteristics based on the aforementioned conditioning.

In some examples, the generative model 406 is pretrained on a dataset that includes the input images. The generative model 406 has thus learnt the distribution of the input images it handles in the dataset expansion pipeline 400. As an example, the generative model 406 generates five candidate images per input image 402. However, this number is selectable or adjustable based on various factors, such as scarcity or imbalance in an initial dataset. The class label 408 serves as a conditioning signal, ensuring generated images maintain class-specific characteristics.

The candidate images 410 are automatically fed into the OOD detection component 204, where a masking component 412 of the OOD detection component 204 alters each of the candidate images 410 to produce respective masked images 414. The same generative model 406 then reconstructs the masked portions to enable the generation of reconstructed images 416 for the respective candidate images 410. For example, the output of the generative model 406 can be directly used as the reconstructed images 416, or the reconstructed images 416 can be formed by taking regions corresponding to the mask from the output of the generative model 406 and applying those regions to the masked images 414 to produce the reconstructed images 416. In some examples, masks are randomly selected and applied to create partially obscured versions of candidate images. The masking process serves as a structural guidance mechanism, indicating to the generative model 406 which portions of the image need to be reconstructed. The generative model 406 may also receive the predicted class label as further guidance for the generation process.

Once the reconstructed images 416 have been generated, the OOD detection component 204 identifies OOD samples. For example, the OOD detection component 204 calculates a perceptual distance score between each of the candidate images 410 and a corresponding one of the reconstructed images 416. Images exceeding a predetermined similarity threshold are filtered out by the OOD detection component 204.

In this way, and as shown in FIG. 4, the OOD detection component 204 starts with the candidate images 410 and then separates the candidate images 410 into one or more in-domain image(s) 418 and one or more OOD image(s) 420. As mentioned, the generative model 406 may be configured such that it can effectively reconstruct images within the distribution it was trained on but encounters difficulties with OOD samples. This principle enables the dataset expansion system 134 to use reconstruction accuracy as a proxy for determining whether generated images maintain consistency with the original dataset distribution.

Each of the in-domain image(s) 418 is added to a dataset 422. For example, an initial dataset is expanded by adding each of the in-domain image(s) 418 together with the class label 408.

In some examples, at least some of the components shown in FIG. 2 or FIG. 4 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

To assess the effectiveness of approaches described in the present disclosure, an experiment was conducted on a subset of 10,000 images selected from the 50,000 training images in the publicly available CIFAR100 dataset. The CIFAR100 dataset was developed by the Canadian Institute for Advanced Research (CIFAR) and is used in the field of computer vision in the development and testing of machine learning models.

Using a class-aware image generator similar to the image generation component 202 described with reference to FIG. 2, five new, synthetic images were generated for each original image, resulting in a total of 60,000 images for training, as shown in Table 1 below. After applying OOD detection on the synthetic images using a detector similar to the OOD detection component 204 described with reference to FIG. 2, outliers were removed, leaving 39,742 images. In this experiment, therefore, a significant percentage of candidate images were filtered for lack of sufficient similarity to their corresponding reconstructed images.

A ResNet50 classifier model was trained on each of the datasets shown in Table 1, with Table 1 illustrating classification accuracy achieved by the respective models. It is evident from the results in Table 1 that a system of the present disclosure can provide useful expanded datasets, enhancing overall feature diversity while remaining substantially within the domain of the original dataset. By avoiding OOD samples, the resulting model's classification accuracy can be improved.

TABLE 1
Test results

| Dataset | Accuracy (%) |
|---|---|
| CIFAR100* (10,000 images) | 50.61 |
| CIFAR100* plus 50,000 new images | 61.73 |
| generated from CIFAR100* via class- | |
| aware image generation (60,000 | |
| images in total) | |
| CIFAR100* plus new images after | 62.58 |
| OOD filtering with 0.05 threshold | |
| (39,742 images) | |

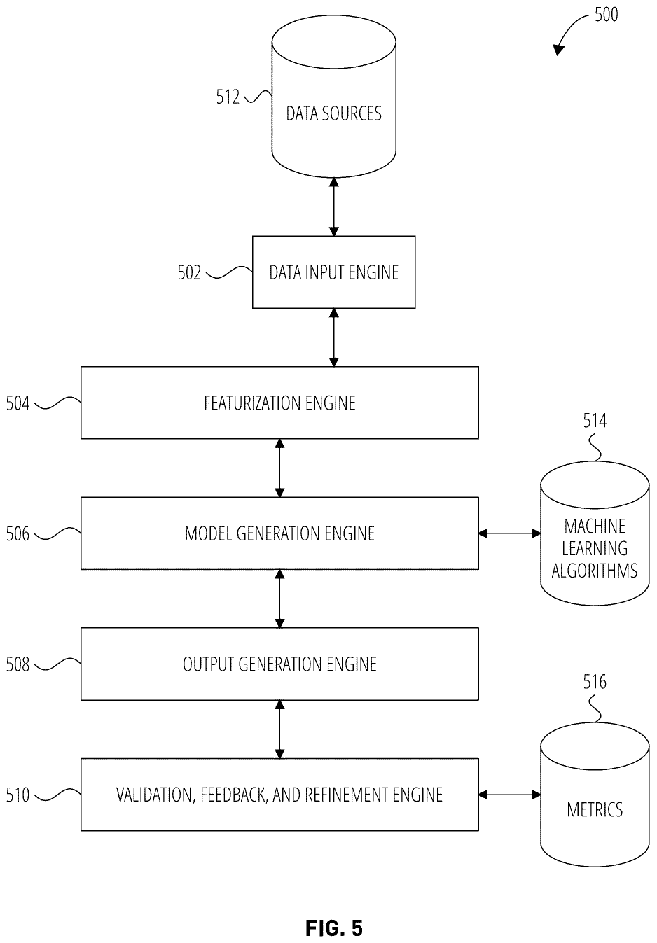

FIG. 5 illustrates a machine learning system 500, according to some examples. The machine learning system 500 may be used to implement aspects of the present disclosure. The machine learning system 500 is shown to include a data input engine 502, a featurization engine 504, a model generation engine 506, an output generation engine 508, and a validation, feedback, and refinement engine 510.

The data input engine 502 may be configured to access, interpret, request, format, re-format, or receive input data from data sources 512. Data sources 512 may include training data (e.g., data for training machine learning models), validation data (e.g., data for comparing model output with known results to evaluate performance), or reference data (e.g., data used to establish baselines or inform model creation). The data input engine 502 can interact with external data systems via input/output (I/O) devices, network interfaces, or storage elements to ensure input data is processed and stored in a suitable format for further operations.

The featurization engine 504 may be configured to transform input data into features that are optimized or useful for machine learning. The featurization engine 504 can handle feature extraction, scaling, or selection, enabling the machine learning system 500 to identify and process relevant data attributes for subsequent modeling. For example, features extracted from raw data may be annotated, labeled, or transformed into numerical representations suitable for machine learning algorithms 514. The featurization engine 504 can work iteratively with other components to refine features based on model requirements or outcomes.

The model generation engine 506 is responsible for creating, training, and configuring one or more machine learning models based on input data and selected features. The model generation engine 506 may include functionality for model selection, hyperparameter tuning, or algorithm implementation.

Machine learning broadly involves using computer algorithms to automatically learn patterns and/or relationships in data, often without the need for explicit programming. Thus, the machine learning algorithms 514 may include various algorithms, including supervised, unsupervised, or reinforcement learning approaches, such as decision trees, neural networks, Support Vector Machines (SVMs), or deep learning architectures such as transformers or Convolutional Neural Networks (CNNs). The model generation engine 506 may also support iterative model refinement and validation cycles, enabling adaptability to evolving data or performance criteria.

In some examples, the output generation engine 508 is responsible for model inference. The output generation engine 508 processes data to produce predictions, classifications, or other results. The output generation engine 508 can also apply post-processing techniques such as aggregation, thresholding, or confidence scoring to ensure outputs are in a format suitable for downstream systems or user interpretation.

The validation, feedback, and refinement engine 510 may be configured to validate, monitor, or improve the performance and relevance of machine learning models over time. The validation, feedback, and refinement engine 510 can apply validation data to assess model outputs and integrates feedback from users or automated systems to improve models. Metrics 516 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 500 may be implemented by hardware processors and may communicate via network interfaces or shared storage elements to facilitate data exchange and coordination. The architecture shown in FIG. 5 allows for flexible deployment across various machine learning applications, such as natural language processing, computer vision, or predictive analytics.

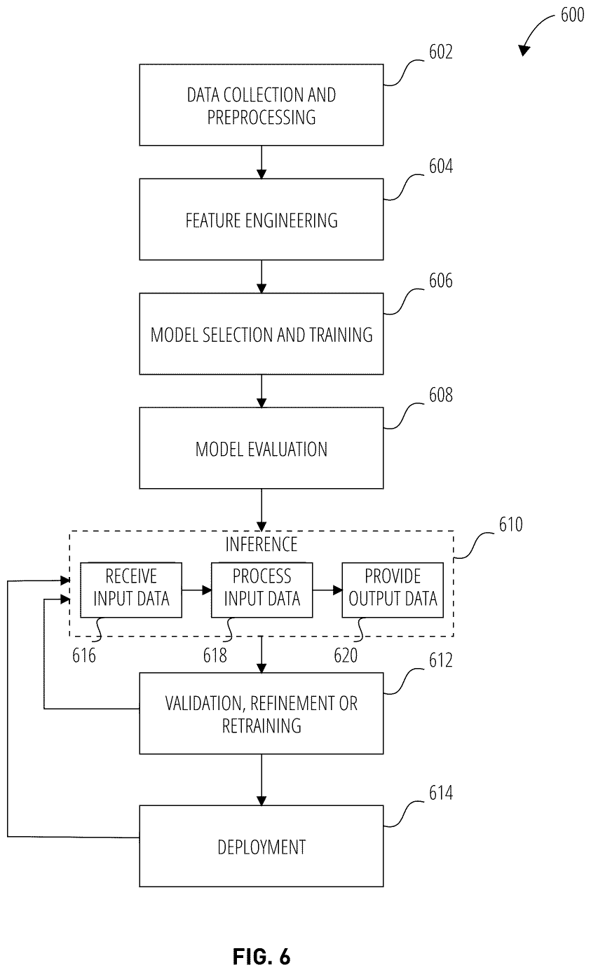

FIG. 6 is a flowchart depicting a machine learning pipeline 600, according to some examples. The machine learning pipeline 600, or parts thereof, may be used to generate a trained machine learning model for use in examples of the present disclosure. In some examples, a system such as the machine learning system 500 of FIG. 5 is used to implement the machine learning pipeline 600.

The machine learning pipeline 600 commences with a data collection and preprocessing stage 602, in which data is acquired, cleaned, or formatted for compatibility with machine learning algorithms. The data collection and preprocessing stage 602 may also involve addressing issues such as duplicate entries, missing values, or data inconsistencies.

During a feature engineering stage 604, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be a variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 606 can include selecting an appropriate machine learning algorithm or strategy and training the relevant model on training data. The model selection and training stage 606 may involve splitting the data into training and testing sets, using cross-validation to evaluate the model, and tuning hyperparameters to improve performance. During training, the model may be trained to find features that affect a predicted outcome. The result of the training is a trained machine learning model.

In some examples, techniques such as model quantization, pruning, or knowledge distillation can reduce the computational complexity of a trained model. Quantization involves reducing the precision of weights and activations (e.g., from 32-bit floating-point to 8-bit integers), enabling efficient deployment on hardware-constrained environments such as edge devices. Pruning removes redundant or non-contributory connections within a model, thereby reducing memory and processing requirements. Knowledge distillation transfers the learned knowledge of a large, complex model into a smaller, lightweight model.

A model evaluation stage 608 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 6 further shows an inference stage 610, in which a trained model generates outputs on new, unseen data. For example, for each input, at operation 616, the model receives input data (e.g., from external sources, such as real-time sensors, databases, or user-provided queries, or internal sources such as test inputs). At operation 618, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 620.

It is noted that output data may take various forms. In classification AI examples, outputs may include data classifications or probabilities linked to particular classifications. In generative AI examples, outputs may include new content, such as translations, summaries, answers, new media content, or combinations thereof. In some examples, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 600 may also include a validation, refinement, or retraining stage 612. This may include updating a model based on feedback generated from the inference stage 610, such as new data or user feedback. In some examples, validation is performed using a separate dataset known as the validation dataset. The validation dataset can be used to tune or fine-tune the hyperparameters of a model, such as the learning rate and the regularization parameter. The hyperparameters may be adjusted to improve the model's performance on the validation dataset.

During deployment stage 614, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some examples, the trained model is deployed on a single device, such as locally on an end user's computing device or on an edge device, as opposed to being deployed on a server system. This may provide lower latency or offline functionality in certain scenarios. Accordingly, various trained models can be deployed as server-based deployments or on-device deployments.

In some examples, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

As mentioned, a generative AI model can generate new content. For example, generative AI can produce text, images, video, audio, code, or synthetic data. In some examples, the generated content may be similar to original data, but not identical.

Some of the techniques or architectures that may be used in generative AI are GANs, Variational Autoencoders (VAEs), and transformers. GANs may include two neural networks: a generator and a discriminator. The generator network attempts to create realistic content that can “fool” the discriminator network, while the discriminator network attempts to distinguish between real and fake content. The generator and discriminator networks compete with each other and improve over time. VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models may use attention mechanisms to learn the relationships between different parts of input data (such as words or pixels) and generate output data based on these relationships. In some examples, transformer models can handle sequential data, such as text or speech, as well as non-sequential data, such as images or code.

A diffusion model is an example of a generative model that can be used to generate synthetic images for use in examples of the present disclosure. A diffusion model is trained to iteratively denoise an image by reversing a diffusion process. Starting with randomly sampled noise, for example, a trained diffusion model can iteratively denoise data to yield a final image sample.

For instance, Stable Diffusion provides an architecture including a U-Net backbone with approximately 1 billion parameters, utilizing skip connections to enhance feature propagation. The U-Net architecture has multiple layers, employing ReLU (Rectified Linear Unit) activation functions and multi-head attention mechanisms. Connections within the model include convolutional layers and dilated convolutions.

In some examples, a diffusion model is trained by employing stochastic gradient descent (SGD) with a learning rate schedule defined by a cosine annealing strategy. The objective is to minimize a denoising loss function, which measures the difference between predicted and true noise in the input.

The training data used for training a diffusion model can be sourced from publicly available image datasets, such as LAION-5B, ImageNet, or CIFAR. In some examples, the training data is specific to an entity, application, or use case. For example, a diffusion model can be trained on an initial dataset of labeled images, with the intention being to expand the initial dataset without significantly deviating from the original data distribution, as described in the present disclosure. In a manufacturing context, for example, the diffusion model can be trained on a collection of images depicting either defective or non-defective products or parts.

The training data may include representative variations of the relevant parameters, such as image resolutions, noise levels, and content diversity. Input data to the diffusion model may include noisy image tensors, and output of the diffusion model represents denoised image tensors approximating high-quality, clean versions of input images. In some examples, training data undergoes validation to ensure quality and representativeness. This includes checks for missing values, outliers, and duplicates. For example, outlier detection is performed using a z-score analysis, and invalid data points are excluded. Data augmentation techniques, such as random cropping, flipping, and rotation, are applied to enhance data diversity.

A diffusion model can be trained to generate images based on multiple inputs, such as image and text input (e.g., an input image and a class label in text format). Such inputs serve as structural guidance. In some examples, the model is designed to integrate these inputs as conditioning signals during the denoising process. Each guidance input, such as a text description, a masked image, or a segmentation map, is encoded into a shared latent space using appropriate encoders. These encoded representations are combined and injected into the diffusion process, steering the model to generate outputs that adhere to the provided structural constraints. The model is trained with a loss function that ensures the generated output matches the target while maintaining consistency with all guidance inputs.

For example, to train a diffusion model to generate an image based on both an input image and a text description, the model can be designed to learn a mapping from a combined input space to a target image space. During training, the input image and text description are encoded into a shared latent space using encoders, such as a CNN for images and a transformer or recurrent network for text. The latent representations are fused and conditioned into the diffusion process, which iteratively denoises random noise into a high-quality output image.

A diffusion model can be deployed in various environments, including cloud, on-premises, or edge devices. Deployment considerations include optimizing for latency and throughput, ensuring compatibility with container orchestration platforms such as Kubernetes, and adhering to security standards.

A ResNet model is an example of an image classifier model that can be used to process images and output classifications (e.g., class labels) for use in examples of the present disclosure. This type of model can include a sequence of residual blocks to facilitate gradient flow during training. For instance, the ResNet50 architecture has 50 layers, including convolutional layers with ReLU activations, batch normalization, and shortcut connections. ResNet50 can be divided into four main parts: the convolutional layers, the identity block, the convolutional block, and the fully connected layers. The convolutional layers are responsible for extracting features from the input image, while the identity block and convolutional block are responsible for processing and transforming these features. Finally, the fully connected layers are used to make the final classification. Alternative models, such as ViT, use a different architecture consisting of transformer encoders with self-attention mechanisms to model global image dependencies.

The ResNet model can be trained using supervised learning techniques. In some examples, the training data used for this process is sourced from publicly available datasets such as ImageNet or CIFAR. As mentioned with reference to the diffusion model above, in some examples, the training data is specific to an entity, application, or use case. Input data to the model may include RGB images resized to a fixed resolution. The output of the model may represent a probability distribution over the target classes. In some examples, the model generates outputs such as class probabilities or a top-5 prediction list, which can be formatted as objects or graphical labels. Postprocessing may include applying a softmax function to ensure that the predicted probabilities sum to 1.

An image classifier model, such as ResNet, can be deployed in various environments, including cloud, on-premises, or edge devices. Deployment considerations include optimizing for latency, throughput, and memory efficiency.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a computer-implemented method comprising: for each input image of a plurality of input images: processing, by at least one hardware processor, the input image to obtain a class label for the input image; executing, by the at least one hardware processor, a generative model, trained on an initial dataset, to generate a plurality of candidate images (e.g., a plurality of synthetic image options) based on the input image and the class label; applying, by the at least one hardware processor, a mask to each of the plurality of candidate images to obtain a plurality of masked images; reconstructing, by the at least one hardware processor, the plurality of masked images to obtain a plurality of reconstructed images; and filtering, by the at least one hardware processor, the plurality of candidate images to obtain one or more validated images, the filtering comprising removing one or more of the plurality of candidate images based on dissimilarity between each of the one or more removed candidate images and a corresponding one of the plurality of reconstructed images; and storing, by the at least one hardware processor, an expanded dataset comprising at least a subset of the initial dataset and the one or more validated images associated with each of the plurality of input images.

In Example 2, the subject matter of Example 1 includes, wherein the processing of the input image to obtain the class label comprises executing an image classifier model to process the input image and predict the class label, the computer-implemented method further comprising: training the image classifier model on the initial dataset.

In Example 3, the subject matter of any of Examples 1-2 includes, training the generative model on the initial dataset prior to generating the plurality of candidate images.

In Example 4, the subject matter of any of Examples 1-3 includes, wherein the reconstructing of the plurality of masked images comprises, for each masked image of the plurality of masked images: performing image inpainting to obtain intermediate output associated with a candidate image of the plurality of candidate images from which the masked image was generated; extracting regions associated with the mask from the intermediate output; and overlaying the extracted regions onto the masked image or the candidate image to obtain a reconstructed image.

In Example 5, the subject matter of any of Examples 1-4 includes, wherein the reconstructing of the plurality of masked images comprises performing image inpainting, and the image inpainting comprises, for each masked image, executing the generative model using the masked image and the class label as inputs.

In Example 6, the subject matter of any of Examples 1-5 includes, accessing the initial dataset to obtain the plurality of input images.

In Example 7, the subject matter of any of Examples 1-6 includes, for each candidate image of the plurality of candidate images, generating a value indicative of similarity between the candidate image and the corresponding one of the plurality of reconstructed images; and comparing the value with a predetermined threshold to determine whether to remove the candidate image.

In Example 8, the subject matter of Example 7 includes, wherein the value is a perceptual distance score.

In Example 9, the subject matter of any of Examples 1-8 includes, wherein the initial dataset comprises the plurality of input images and a corresponding class label for each of the plurality of input images, and wherein the expanded dataset comprises, for each validated image of the validated images, the class label for the input image that was used to generate the validated image.

In Example 10, the subject matter of any of Examples 1-9 includes, wherein the initial dataset is an imbalanced classification dataset, the computer-implemented method further comprising compensating for imbalance in the initial dataset by dynamically controlling at least one of: selection of the plurality of input images from a data source; or a number of the plurality of candidate images generated from one or more of the plurality of input images.

In Example 11, the subject matter of Example 10 includes, wherein the controlling comprises oversampling from at least one minority class present in the initial dataset to increase a proportion of the at least one minority class in the expanded dataset.

In Example 12, the subject matter of any of Examples 1-11 includes, wherein the expanded dataset comprises images with corresponding class labels, the computer-implemented method further comprising: training an image classifier model on the expanded dataset.

In Example 13, the subject matter of any of Examples 1-12 includes, wherein the generative model comprises a diffusion model.

In Example 14, the subject matter of any of Examples 1-13 includes, wherein the class label indicates whether the input image depicts a product defect.

Example 15 is a system comprising: at least one hardware processor; and a non-transitory computer-readable medium storing instructions that, when executed by the at least one hardware processor, cause the at least on hardware processor to perform operations comprising: for each input image of a plurality of input images: processing the input image to obtain a class label for the input image; executing a generative model, trained on an initial dataset, to generate a plurality of candidate images based on the input image and the class label; applying a mask to each of the plurality of candidate images to obtain a plurality of masked images; reconstructing the plurality of masked images to obtain a plurality of reconstructed images; and filtering the plurality of candidate images to obtain one or more validated images, the filtering comprising removing one or more of the plurality of candidate images based on dissimilarity between each of the one or more removed candidate images and a corresponding one of the plurality of reconstructed images; and storing an expanded dataset comprising at least a subset of the initial dataset and the one or more validated images associated with each of the plurality of input images.

In Example 16, the subject matter of Example 15 includes, wherein the processing of the input image to obtain the class label comprises executing an image classifier model to process the input image and predict the class label, the operations further comprising: training the image classifier model on the initial dataset.

In Example 17, the subject matter of any of Examples 15-16 includes, the operations further comprising: training the generative model on the initial dataset prior to generating the plurality of candidate images.

Example 18 is one or more non-transitory computer-readable media storing computer-executable instructions that, when executed by a computing system, cause the computing system to perform operations comprising: for each input image of a plurality of input images: processing the input image to obtain a class label for the input image; executing a generative model, trained on an initial dataset, to generate a plurality of candidate images based on the input image and the class label; applying a mask to each of the plurality of candidate images to obtain a plurality of masked images; reconstructing the plurality of masked images to obtain a plurality of reconstructed images; and filtering the plurality of candidate images to obtain one or more validated images, the filtering comprising removing one or more of the plurality of candidate images based on dissimilarity between each of the one or more removed candidate images and a corresponding one of the plurality of reconstructed images; and storing an expanded dataset comprising at least a subset of the initial dataset and the one or more validated images associated with each of the plurality of input images.

In Example 19, the subject matter of Example 18 includes, wherein the processing of the input image to obtain the class label comprises executing an image classifier model to process the input image and predict the class label, the operations further comprising: training the image classifier model on the initial dataset.

In Example 20, the subject matter of any of Examples 18-19 includes, the operations further comprising: training the generative model on the initial dataset prior to generating the plurality of candidate images.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

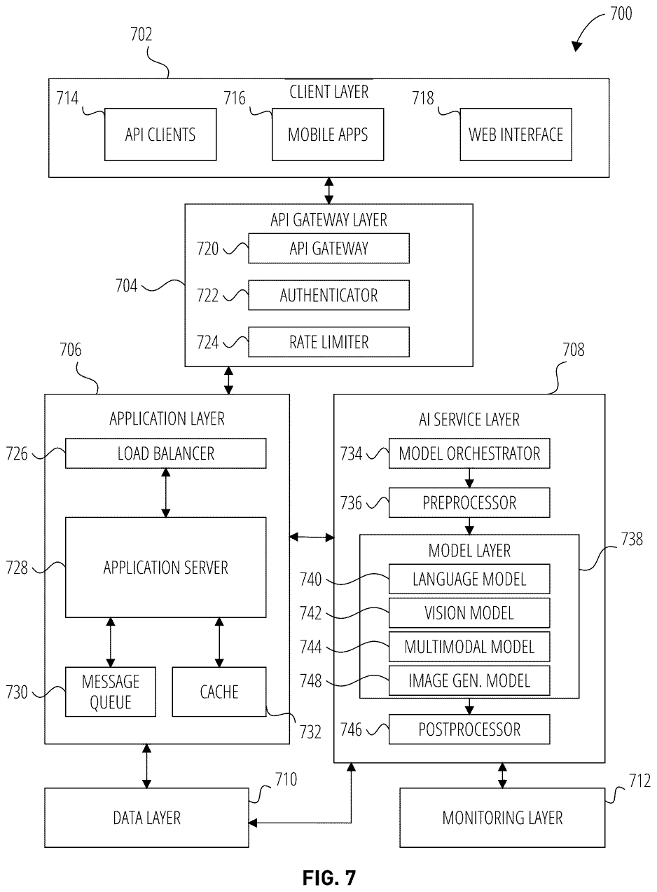

FIG. 7 is a system architecture diagram showing a layered view of an AI integrated system 700, according to some examples. The AI integrated system 700 comprises six example layers: a client layer 702, an API gateway layer 704, an application layer 706, an AI service layer 708, a data layer 710, and a monitoring layer 712.

The client layer 702 provides multiple access points for system interaction. It includes API clients 714, which may enable programmatic access to the capabilities of the AI integrated system 700 or integration with third-party systems and services. Mobile applications 716 facilitate access from mobile applications and devices, for example implementing native mobile protocols while maintaining consistent communication patterns with backend systems. A web interface 718 enables browser-based access to the capabilities of the AI integrated system 700 and may communicate with other layers using, for example, Hypertext Transfer Protocol (HTTP) or Hypertext Transfer Protocol Secure (HTTPS) protocols.

The API gateway layer 704 serves as an entry point for client communications. The API gateway layer 704 comprises an API gateway 720, which may implement routing logic to direct incoming requests to appropriate backend services. An authenticator 722 validates client credentials, for example using industry-standard protocols, such as OAuth 2.0 (Open Authorization 2.0) or JWT (JSON Web Tokens). In some examples, a rate limiter 724 of the API gateway layer 704 operates to prevent system abuse or ensure resource allocation among clients.

The application layer 706 comprises various processing capabilities. In some examples, the application layer 706 includes a load balancer 726 that may distribute incoming requests across multiple application server instances to support resource utilization and system reliability. An application server 728 may implement business or core functional logic of the AI integrated system 700, processing requests and coordinating responses across various system components. In some examples, a message queue 730 facilitates asynchronous processing capabilities, enabling efficient handling of operations, and a cache 732 operates within the application layer 706 to improve response times for frequently requested data.

The AI service layer 708 provides AI capabilities through a structured approach to model deployment and execution. In some examples, the AI service layer 708 includes a model orchestrator 734 that coordinates the execution of one or various AI models, managing resource allocation and implementing routing logic to direct requests to appropriate model instances. A preprocessor 736 may prepare input data for model consumption, implementing transformations, validations, or other preprocessing operations.

FIG. 7 shows the AI service layer 708 as including a model layer 738. The model layer 738 may include multiple model types, including, for example, one or more of: a language model 740 for processing textual input, implementing natural language processing capabilities; a vision model 742 for handling image or video processing tasks; a multimodal model 744 that combines multiple input types to provide comprehensive analysis capabilities; and an image generation model 748 that is specifically trained for automated image generation. In some examples, a postprocessor 746 of the AI service layer 708 transforms model outputs into standardized formats suitable for client consumption. The data layer 710 provides persistent storage capabilities.

While not detailed in FIG. 7, it is noted that the data layer 710 may include various components such as a primary database for maintaining transactional data, a vector database for optimizing storage and retrieval of high-dimensional vectors used in AI applications and models of the AI service layer 708, or a file storage component for managing binary data assets.

The monitoring layer 712 may provide observability capabilities across the AI integrated system 700. This may include logging for capturing system events, metrics collection for performance analysis, or distributed tracing for detailed analysis of request flow through the system.

Communication between layers of the AI integrated system 700 may follow defined patterns. External communications may implement appropriate encryption protocols, for example utilizing Transport Layer Security (TLS) or Secure Sockets Layer (SSL) for data protection. Internal communications may use various protocols selected for specific use cases, for example, Hypertext Transfer Protocol version 2 (HTTP/2), gRPC (Google Remote Procedure Call), or proprietary protocols where appropriate.

Referring again to the model layer 738, this layer may incorporate various types of machine learning models. Neural networks may be deployed to implement various architectures suited to specific processing needs. These can include, merely for example, fundamental feedforward neural networks for pattern recognition, CNNs that may be specialized for processing visual information, RNNs that may be designed for sequential data, transformer networks, or other architectures.

A language model such as the language model 740 may use transformer-based architectures (e.g., Bidirectional Encoder Representations from Transformers (BERT), Generative Pre-trained Transformer (GPT) variants, or Text-to-Text Transfer Transformer (T5)) for processing textual data and implementing natural language understanding capabilities. A vision model such as the vision model 742 may employ specialized neural network architectures (e.g., CNNs, ViT, or ResNet variants) for processing visual information and extracting features from images or video streams. A multimodal model such as the multimodal model 744 may implement hybrid architectures (e.g., Contrastive Language-Image Pre-training (CLIP), DALL-E variants, or multimodal transformers) designed to process and correlate information across different input modalities, leveraging ensemble approaches to combine multiple model types using model aggregation or weighted prediction strategies. A multimodal model may combine textual, visual, and other forms of input data to provide analysis and generate integrated outputs that leverage cross-modal understanding capabilities. A dedicated image generator such as the image generation model 748 may, for example, be based on a diffusion model architecture (e.g., Stable Diffusion).

The AI service layer 708 may provide both supervised learning models (e.g., decision trees, random forests, or support vector machines) for specific classification and prediction tasks, and unsupervised learning models (e.g., k-means clustering or principal component analysis) for pattern discovery and dimensionality reduction within the data processing pipeline. Probabilistic models (e.g., Bayesian networks or hidden Markov models) may be integrated within the AI service layer 708 to handle uncertainty in decision-making processes, working in conjunction with the preprocessor 736 and postprocessor 746 components to provide probability estimates and confidence metrics for model outputs.

Each model type may be implemented using various deployment strategies, with the model orchestrator 734 managing their execution and resource allocation to ensure adequate performance and efficient system operation. This may include coordinating the deployment and execution of various model types, ensuring efficient resource allocation, and appropriate model selection based on specific task requirements. While in some examples the model layer 738 provides server-based access to one or more models, a model can alternatively (or additionally) be deployed so as to perform inference locally (e.g., at the client layer 702).

FIG. 8 is a block diagram of a machine in the example form of a computing system 800, according to some examples, within which instructions 824 may be executed for causing the computing system 800 to perform one or more of the methodologies discussed herein. In some examples, the computing system 800 includes a machine that operates as a standalone device, while in other examples the computing system 800 includes a machine that is connected (e.g., networked) to other machines. The computing system 800 can provide or form part of an operating environment in which aspects of the present disclosure are implemented.

In a networked deployment, a machine may operate in the capacity of a server or a client machine in server-client network environment, or as a peer machine in a peer-to-peer (or distributed) network environment. The machine may be a computer, a tablet, a cellular telephone, a web appliance, or other machine capable of executing instructions (sequential or otherwise) that specify actions to be taken by that machine. It is noted that while components typically related to only a single machine are illustrated in FIG. 8, the term “machine” shall also be taken to include any collection of machines that individually or jointly execute a set (or multiple sets) of instructions to perform any one or more of the methodologies discussed herein. The computing system 800 may thus include multiple connected machines. Computing devices can be connected by a network.

The example computing system 800 includes one or more processor(s) 802 (e.g., a Central Processing Unit (CPU), a Graphics Processing Unit (GPU), or both), a primary or main memory 804, and a static memory 806, which communicate with each other via one or more communication connections 808 (e.g., a bus, controller, or network connection). The computing system 800 may further include one or more output devices, such as a display unit 810 (e.g., a liquid crystal display (LCD) or Light-emitting diode (LED) display).

The computing system 800 also includes one or more input devices, such as an input device 812 (e.g., a keyboard or a touch-sensitive display screen), a navigation device 814 (e.g., a mouse), storage 816, a signal generation device 818 (e.g., a speaker), and a network interface device 820. The storage 816 includes a machine-readable medium 822 on which is stored one or more sets of data structures and instructions 824 (e.g., software) embodying or utilized by one or more of the methodologies or functions described herein. The instructions 824 may also reside, completely or at least partially, within the main memory 804 or within the processor(s) 802 during execution thereof by the computing system 800, with the main memory 804 and the processor(s) 802 also each constituting a machine-readable medium 822.

While the machine-readable medium 822 is shown in accordance with some examples to be a single medium, the term “machine-readable medium” may include a single medium or multiple media (e.g., a centralized or distributed database, or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of a machine-readable medium 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 824 may further be transmitted or received over a communications network 826 using a transmission medium. The instructions 824 may be transmitted using the network interface device 820 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 824 for execution by the machine, and includes digital or analog communications signals or other intangible media to facilitate communication of such software.

Typically, operating system software (not shown) provides an operating environment for software executing in the computing system 800, and coordinates activities of the components of the computing system 800. One or more API calls may be made between components of the computing system 800, or between a component of the computing system 800 and an external component, based on user input received at the computing system 800.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a CPU, a Reduced Instruction Set Computing (RISC) Processor, a Complex Instruction Set Computing (CISC) Processor, a GPU, a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

Operations of example methods described herein may be performed, at least partially, by one or more processors that are temporarily configured (e.g., by software) or permanently configured to perform the relevant operations. The performance of certain of the operations may be distributed among the one or more processors, not only residing within a single machine, but deployed across a number of machines. A hardware-implemented component for performing method operations may comprise dedicated circuitry or logic that is permanently configured (e.g., as a special-purpose processor, such as an FPGA or an ASIC) to perform certain operations. A hardware-implemented component may also comprise programmable logic or circuitry (e.g., as encompassed within a general-purpose processor or another programmable processor) that is temporarily configured by software to perform certain operations.

One or more processors may operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs). In practice, cloud-based, on-premises-based, or hybrid scenarios can be supported in some examples.

Examples may be implemented in digital electronic circuitry, or in computer hardware, firmware, or software, or in combinations of them. Examples may be implemented using a computer program product, such as a computer program tangibly embodied in an information carrier (e.g., in a machine-readable medium for execution by, or to control the operation of, data processing apparatus, such as a programmable processor, a computer, or multiple computers). A computer program can be written in any suitable form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

Although specific examples are described herein, it will be evident that various modifications and changes may be made to these examples without departing from the broader spirit and scope of the disclosure. Accordingly, the specification and drawings are to be regarded in an illustrative rather than a restrictive sense. Examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that the present disclosure can also cover adaptations, combinations, or variations of various examples, including structural or logical substitutions and changes.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A computer-implemented method comprising:
for each input image of a plurality of input images:
processing, by at least one hardware processor, the input image to obtain a class label for the input image;
executing, by the at least one hardware processor, a generative model, trained on an initial dataset, to generate a plurality of candidate images based on the input image and the class label;
applying, by the at least one hardware processor, a mask to each of the plurality of candidate images to obtain a plurality of masked images;
reconstructing, by the at least one hardware processor, the plurality of masked images to obtain a plurality of reconstructed images; and
filtering, by the at least one hardware processor, the plurality of candidate images to obtain one or more validated images, the filtering comprising removing one or more of the plurality of candidate images based on dissimilarity between each of the one or more removed candidate images and a corresponding one of the plurality of reconstructed images; and
storing, by the at least one hardware processor, an expanded dataset comprising at least a subset of the initial dataset and the one or more validated images associated with each of the plurality of input images.

2. The computer-implemented method of claim 1, wherein the processing of the input image to obtain the class label comprises executing an image classifier model to process the input image and predict the class label, the computer-implemented method further comprising:
training the image classifier model on the initial dataset.

3. The computer-implemented method of claim 1, further comprising:
training the generative model on the initial dataset prior to generating the plurality of candidate images.

4. The computer-implemented method of claim 1, wherein the reconstructing of the plurality of masked images comprises, for each masked image of the plurality of masked images:
performing image inpainting to obtain intermediate output associated with a candidate image of the plurality of candidate images from which the masked image was generated;
extracting regions associated with the mask from the intermediate output; and
overlaying the extracted regions onto the masked image or the candidate image to obtain a reconstructed image.

5. The computer-implemented method of claim 1, wherein the reconstructing of the plurality of masked images comprises performing image inpainting, and the image inpainting comprises, for each masked image, executing the generative model using the masked image and the class label as inputs.

6. The computer-implemented method of claim 1, further comprising:
accessing the initial dataset to obtain the plurality of input images.

7. The computer-implemented method of claim 1, further comprising:
for each candidate image of the plurality of candidate images, generating a value indicative of similarity between the candidate image and the corresponding one of the plurality of reconstructed images; and
comparing the value with a predetermined threshold to determine whether to remove the candidate image.

8. The computer-implemented method of claim 7, wherein the value is a perceptual distance score.

9. The computer-implemented method of claim 1, wherein the initial dataset comprises the plurality of input images and a corresponding class label for each of the plurality of input images, and wherein the expanded dataset comprises, for each validated image of the validated images, the class label for the input image that was used to generate the validated image.

10. The computer-implemented method of claim 1, wherein the initial dataset is an imbalanced classification dataset, the computer-implemented method further comprising compensating for imbalance in the initial dataset by dynamically controlling at least one of:
selection of the plurality of input images from a data source; or
a number of the plurality of candidate images generated from one or more of the plurality of input images.

11. The computer-implemented method of claim 10, wherein the controlling comprises oversampling from at least one minority class present in the initial dataset to increase a proportion of the at least one minority class in the expanded dataset.

12. The computer-implemented method of claim 1, wherein the expanded dataset comprises images with corresponding class labels, the computer-implemented method further comprising:
training an image classifier model on the expanded dataset.

13. The computer-implemented method of claim 1, wherein the generative model comprises a diffusion model.

14. The computer-implemented method of claim 1, wherein the class label indicates whether the input image depicts a product defect.

15. A system comprising:
at least one hardware processor; and
a non-transitory computer-readable medium storing instructions that, when executed by the at least one hardware processor, cause the at least on hardware processor to perform operations comprising:
for each input image of a plurality of input images:
processing the input image to obtain a class label for the input image;
executing a generative model, trained on an initial dataset, to generate a plurality of candidate images based on the input image and the class label;
applying a mask to each of the plurality of candidate images to obtain a plurality of masked images;
reconstructing the plurality of masked images to obtain a plurality of reconstructed images; and
filtering the plurality of candidate images to obtain one or more validated images, the filtering comprising removing one or more of the plurality of candidate images based on dissimilarity between each of the one or more removed candidate images and a corresponding one of the plurality of reconstructed images; and
storing an expanded dataset comprising at least a subset of the initial dataset and the one or more validated images associated with each of the plurality of input images.

16. The system of claim 15, wherein the processing of the input image to obtain the class label comprises executing an image classifier model to process the input image and predict the class label, the operations further comprising:
training the image classifier model on the initial dataset.

17. The system of claim 15, the operations further comprising:
training the generative model on the initial dataset prior to generating the plurality of candidate images.

18. One or more non-transitory computer-readable media storing computer-executable instructions that, when executed by a computing system, cause the computing system to perform operations comprising:
for each input image of a plurality of input images:
processing the input image to obtain a class label for the input image;
executing a generative model, trained on an initial dataset, to generate a plurality of candidate images based on the input image and the class label;
applying a mask to each of the plurality of candidate images to obtain a plurality of masked images;
reconstructing the plurality of masked images to obtain a plurality of reconstructed images; and
filtering the plurality of candidate images to obtain one or more validated images, the filtering comprising removing one or more of the plurality of candidate images based on dissimilarity between each of the one or more removed candidate images and a corresponding one of the plurality of reconstructed images; and
storing an expanded dataset comprising at least a subset of the initial dataset and the one or more validated images associated with each of the plurality of input images.

19. The one or more non-transitory computer-readable media of claim 18, wherein the processing of the input image to obtain the class label comprises executing an image classifier model to process the input image and predict the class label, the operations further comprising:
training the image classifier model on the initial dataset.

20. The one or more non-transitory computer-readable media of claim 18, the operations further comprising:
training the generative model on the initial dataset prior to generating the plurality of candidate images.
